(19) United States
(12) Patent Application Publication
(10) Pub. No.: US 2016/0026204 A1
(43) Pub. Date: Jan. 28, 2016

(54) High-Voltage to Low-Voltage Low Dropout Regulator with Self Contained Voltage Reference

(71) Applicant: Dialog Semiconductor GmbH, Kirchheim/Teck-Nabem (DE)

(72) Inventor: Guillaume de Cremoux, Edinburgh (GB)

(21) Appl. No.: 14/445,186

(22) Filed: Jul. 29, 2014

(30) Foreign Application Priority Data
Jul. 24, 2014 (EP) 14178436.3

(51) Int. Cl. G05F 3/08

(52) U.S. Cl. CPC G05F 3/08

(57) ABSTRACT

A circuit and method for providing a temperature compensated voltage comprising a voltage regulator circuit configured to provide a regulator voltage, a voltage reference circuit configured to provide a reference voltage, VREF, a comparison circuit configured to provide a control voltage VCTL, and an operational amplifier configured to provide amplification and coupling to said comparison circuit, wherein the voltage can be a high voltage greater than 1.2 V.

### BACKGROUND

1. Field

The disclosure relates generally to a voltage regulator and, more particularly, to a low dropout regulator thereof.

2. Description of the Related Art

Low dropout (LDO) regulators are commonly used to regulate internal voltage supplies at lower voltage from higher voltages. Voltage regulation is important where circuits are sensitive to transients, noise and other types of disturbances. The control of the regulated voltage over variations in both semiconductor process variation, and temperature is key to many applications. Additionally, power consumption is also a key design requirement.

FIG. 1 is a circuit schematic of a prior art low dropout (LDO) regulator with separate bandgap network. FIG. 1 consists of three stages. The first stage, stage 1, establishes the voltage reference. The second stage, stage 2, is the voltage regulator, that uses this reference to make a regulated rail, VREG. The third stage, stage 3, is the Power-On-Reset, which measures the regulated voltage, VREG and generates a rising edge on its output porb when the regulated voltage VREG exceeds a given percentage of its intended regulated value. It is desirable to merge the reference voltage, VREF, and regulated voltage generator VREG, by directly creating a voltage that is temperature compensated.

FIG. 1 shows the circuit power supply voltage VDD 10, and ground VSS 20. The network can be understood as three stages. The first stage provides a voltage reference, VREF, as its output. The second stage consists of an operational amplifier, and a feedback loop which serves as a control of the regulator output transistor. The third stage establishes the regulated voltage, VREG, with a pass transistor, and a load. In the third stage, the output voltage of the network is VOUT 30 is also the regulated voltage VREG. The first operational amplifier OA1 40 produces a reference voltage VREF and is electrically connected to a second operational amplifier OA2 50. The second operational amplifier OA2 50 is electrically coupled to the PFET output device 60. The PFET 60 is electrically coupled to the output VOUT 30 and load element 55. The operational amplifier OA2 50 has a first input 51 and second input 52. The OA2 input signal 52 is connected to resistor feedback network formed from resistor RLH 53, and resistor RLL 54. In the first stage, a resistor RF 70 and resistor RF 75 are electrically coupled to the first and second input of operational amplifier OA1 40. Additionally, resistor RF 70 and RF 75 are coupled to the npn transistors NPN1, and NPN2, respectively. The npn transistor NPN1 80 is coupled to resistor element RPTAT 90. The npn transistor NPN2 85 is coupled to resistor element RA 95.

FIG. 2 is a circuit schematic of a network that provides a R-SHIFT method. FIG. 2 shows a prior art bandgap circuit schematic. From the FIG. 2 circuit schematic, an R-SHIFT method is described. In the circuit 200, the voltage supply VDD 210 supports the network, with a ground VSS 220. The output voltage is the regulated voltage VREG 230 at the output voltage. The operational amplifier OA1 240 provides an output signal to the gate of the PMOS pass transistor 260. A first resistor RF1 270 and second resistor RF2 275 are electrically coupled to the operational amplifier OA1 240. Additionally, there are a first and second device represented as a first diode 280 of size unity, and a second diode 285 of size N. The resistor RPTAT 290 is coupled to the diode 285, RSHIFT resistor 250, and operational amplifier OA1 240.

A shift resistance RSHIFT increases the current through the resistances RF and shifts up from 1.2V to an arbitrarily value VREG. By setting properly RF, RSHIFT, RPTAT and N, VREG is directly compensated in temperature, but this comes at the cost of two very large resistors RF and an operational amplifier.

FIG. 3 illustrates a circuit schematic 300 that highlights the R-String method. In FIG. 3, the bandgap cell is indirectly regulated to 1.25 V through a resistor ladder network. The ground potential VSS is 320, and the output rail VOUT 310 is established by the resistor ladder network, and operational amplifier OA1 340. The regulated voltage node 330 is electrically coupled to the resistor ladder network resistor R3 350 and resistor R4 355. The inputs of the operational amplifier OA1 340 is coupled to resistor RF1 370 and resistor RF2 375. The npn transistor 380 and 385 are coupled to the OA1 input signals. Resistor R1 390 (PTAT resistor), and resistor R2 395 are coupled to the npn transistor 380 and 385.

The output voltage, VOUT, VOUT=VREG is adjusted by the operational amplifier OA1 340 such that its fraction R4/(R3+R4) matches ˜1.25V. Then it is possible to optimize only the left part (bandgap part) to compensate it in temperature, and so the same compensation will also result for VOUT=VREG.

FIG. 4 illustrates an additional circuit schematic 400. In the prior implementation of FIG. 3 is a resistive path between VREG and ground VSS. This will require large resistor values which is not desirable. FIG. 4 is a circuit schematic 400 that utilizes a power supply voltage VDD 410 and ground potential 420. The npn transistor pair NPN1 480 (size N) and NPN2 485 (size 1) are coupled to resistor RPTAT 490 and resistor RS 495. The base of the npn transistors establish the reference voltage VREF and is electrically connected to resistor RH 453, and resistor RL 454. The npn transistor are sourced by current mirror formed by PFET 430A and PFET 430B. The current mirror PFET 430A is connected to the gate of the PFET MPLOOP 425. A second PFET current mirror is electrically coupled to the power supply voltage VDD 410 formed by PFET mirror 435A and 435B. The transistor MPLOOP 425 is coupled to an NFET current mirror 445A and 445B.

The disadvantage of this circuit topology is the sensitivity to the regulated voltage VREG. If the regulated voltage, VREG, has noise, it is amplified because applied on the gate-to-source voltage of the MPLOOP.

FIG. 5 shows a circuit schematic of an indirect PTAT 500. The power supply VDD 510 and the ground reference VSS 520 supplies circuit 500. The network has a PFET current mirror M1 530A and M3 530B. The output pass transistor is a PFET (e.g. PMOS) M4 540. The PFET current mirror maintains a controlled current through the NPN Q1 535 and NPN current mirror formed by Q2 545A and Q3 545B. The base of NPN Q1 is coupled to resistor R1 560, resistor R2 570, and resistor R3 580, as well as NPN Q4 550.

The PTAT effect is done by matching the current in Q2 545A (N elements) with the current in Q1 535 (1 element) through the VREG loop. VREG is adjusted for this matching and {R2 570, R3 580} allow to adjust the value of VREG. This implementation has the following disadvantages and drawbacks:
The loop gain is low, which leads to any fluctuation on VREG becomes as a current (VREG−VBE4)/R2, then copied with a low ratio to Q1. Only the line VCTL offers the gain.
The PSRR is poor because VCTL is supplied referenced. Noise on the power supply node, VDD, is applied on VGSM4 and the loop needs to be very fast to compensate for this noise.
Mostly, it is not high-voltage compliant. For example, if the power supply voltage, VDD, is VDD=20V, then the gate of PMOS transistor M1 530A is 19V and npn Q1 535 will undergo electrical breakdown for a standard 5V process. If transistors are stacked, in a series cascode configuration, the series cascode can protect its collector; this leads to a non-starting loop because the cascodes themselves need to be started, otherwise they are blocking the regulation path. The issue of high voltage compliance is also true for the transistor Q3 545B.
Addressing the issue with series cascode transistors is achievable, but with an impact toe the minimum voltage of operation (e.g. series cascode configuration leads to multiple drain-to-source voltage drops (VDSsat).

U.S. Pat. No. 6,995,587 to Xi, describes a method for generating a bandgap reference current. The method for generating a band gap reference current includes the steps for mirroring the bandgap reference current, summing the mirrored currents, and modulating and outputting a bandgap reference voltage from the sum. Representative preferred embodiments are disclosed in which the methods of the invention are used in providing under-voltage protection and in providing a regulated output voltage. Preferred embodiments of the invention include a bandgap under-voltage detection circuit using a comparator and a voltage regulator circuit having a regulated voltage output capability.

U.S. Pat. No. 6,512,398 to Sonoyama describes a circuit device with improved reliability by minimizing the fluctuations of the detection level of the supply voltage. In the circuit device comprises a differential amplifier circuit that amplifies the differential voltage representing the difference between the reference voltage V_{REF} generated by a reference voltage generating section and the detection voltage obtained by dividing a supply voltage. The reference voltage generating section generates reference voltage V_{REF} from the base-emitter voltage of a bipolar transistor.

A bandgap voltage reference is discussed in the Analog Devices data sheet for AD580. The AD580 Data Sheet discloses a 3-terminal, low cost, temperature-compensated, bandgap voltage reference, which provides a fixed 2.5V output for inputs between 4.5V and 30V. A unique combination of advanced circuit design and thin film resistors provide the AD580 with an initial tolerance of ±0.4%, a temperature stability of better than 10 ppm/° C., and long-term stability of better than 250 μV.

In these prior art embodiments, the solution to establish a utilized various alternative solutions.

### SUMMARY

It is desirable to provide a solution to address an efficient voltage regulator with minimal power consumption.

A principal object of the present disclosure is to provide a circuit with a loop gain VCTL with a ground reference for better power supply rejection ratio (PSRR) and noise immunity.

Another further object of the present disclosure is to provide a circuit that utilized field effect transistors that are voltage tolerant to high voltage.

Another further object of the present disclosure is to provide a circuit that utilizes high voltage field effect transistors to avoid series-cascode of the bipolar junction transistors.

In summary, a circuit providing a temperature compensated voltage comprising a voltage regulator circuit configured to provide a regulator voltage, a voltage reference circuit configured to provide a reference voltage a startup circuit configured to provide a control voltage VCTL, and an operational amplifier configured to provide amplification and coupling to said startup circuit.

In addition, a method is disclosed in accordance with the embodiment of the disclosure. A method of providing a temperature compensated high voltage comprising the steps of a first step, providing a circuit on a semiconductor chip, the circuit comprising a voltage reference generator, and a voltage regulator generator; a second step, establishing a current in transistor QN; a third step, copying the current onto transistor QN1; a fourth step, copying the current back to current mirror {MP1, MPN}; a fifth step, comparing the current in transistor Q1 to current in transistor QN to establish a voltage VCTL; a sixth step, driving the current-mode operational amplifier {MNOA, MPOA, and MP}; and, a seventh step, adjusting a regulator voltage VREG to match currents in transistor Q1 and QN.

Other advantages will be recognized by those of ordinary skill in the art.

### BRIEF DESCRIPTION OF THE DRAWINGS

The present disclosure and the corresponding advantages and features provided thereby will be best understood and appreciated upon review of the following detailed description of the disclosure, taken in conjunction with the following drawings, where like numerals represent like elements, in which:

FIG. 1 is a circuit schematic of a prior art low dropout (LDO) regulator with separate bandgap network;

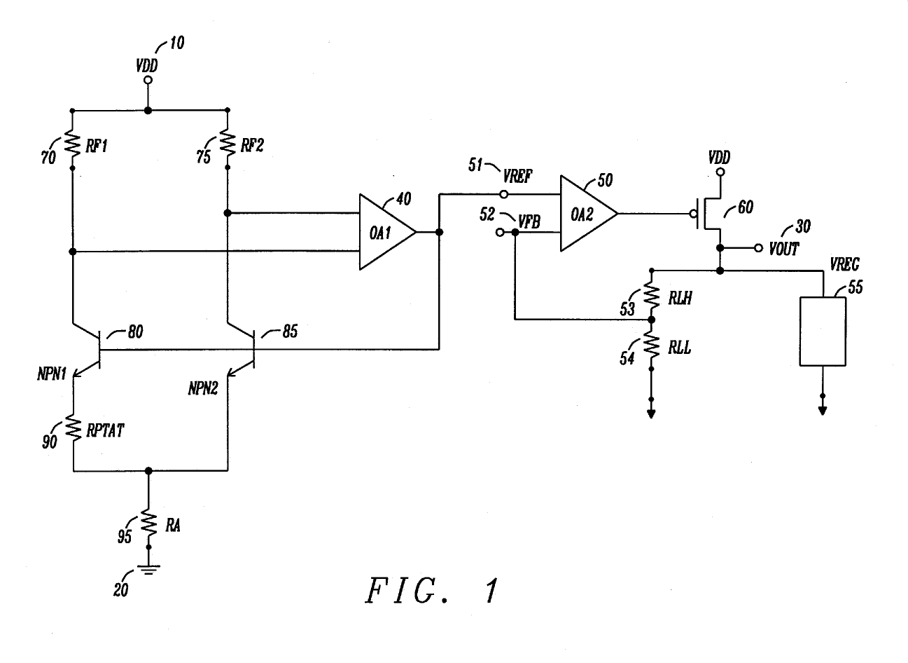

FIG. 2 is a circuit schematic of a prior art network that is T-compensated using a shift resistance to regulate a voltage above the conventional ˜1.20V value;

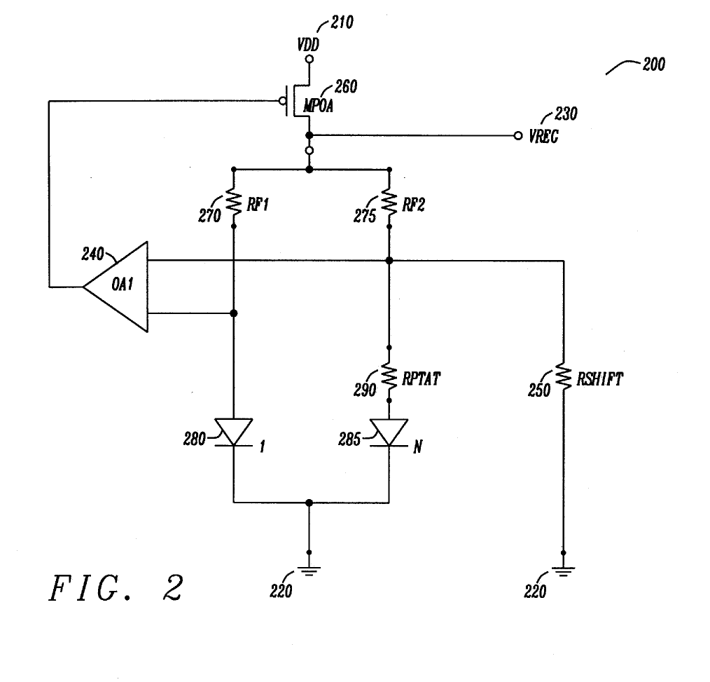

FIG. 3 is a circuit schematic of a prior art network highlighting the R-string method;

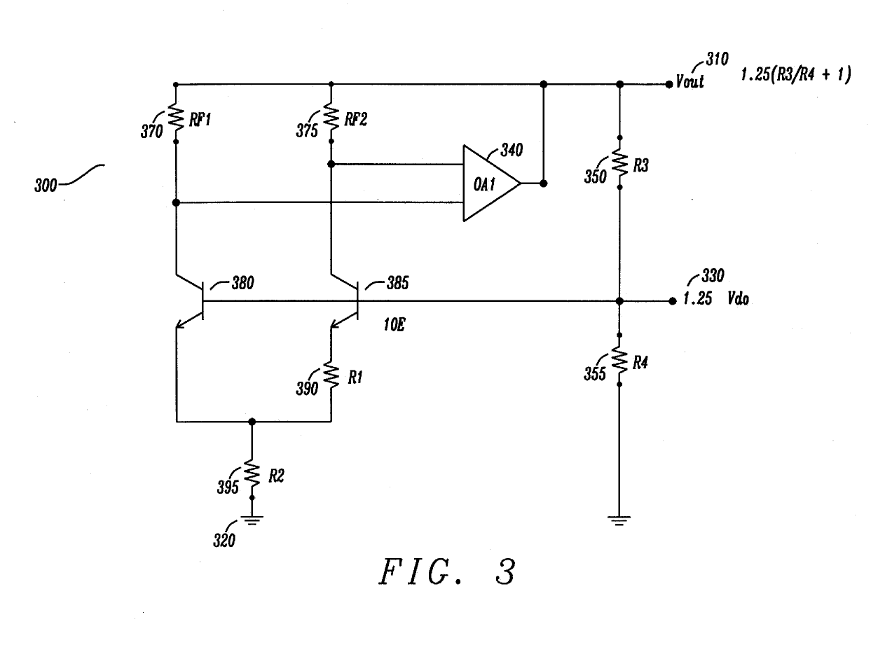

FIG. 4 is a circuit schematic of an improved network of the R-string method network of FIG. 3;

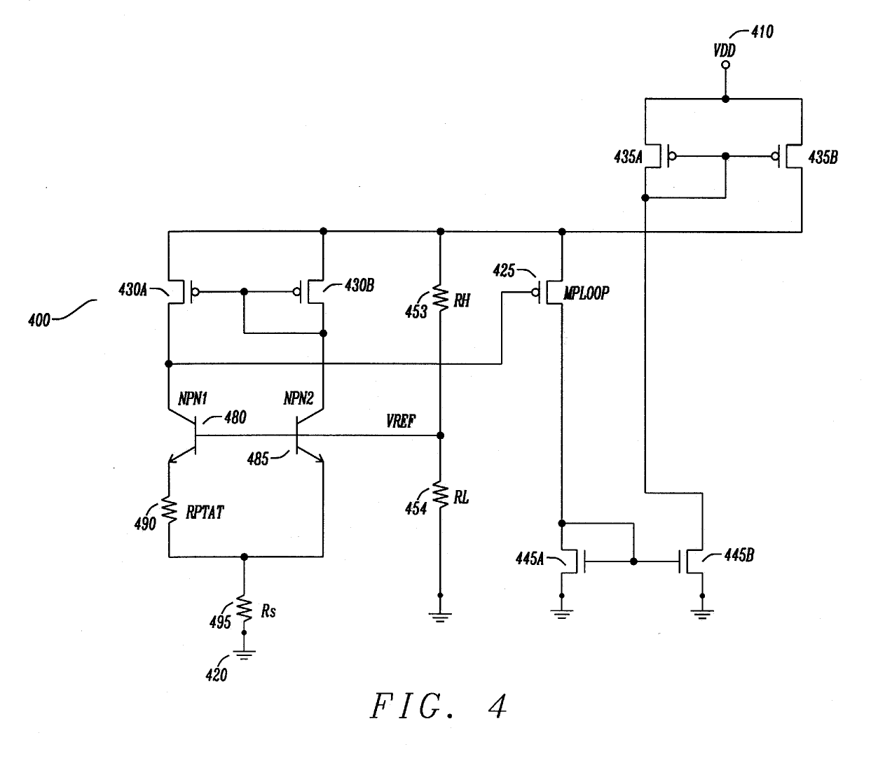

FIG. 5 is a circuit schematic of a prior art network for Indirect PTAT;

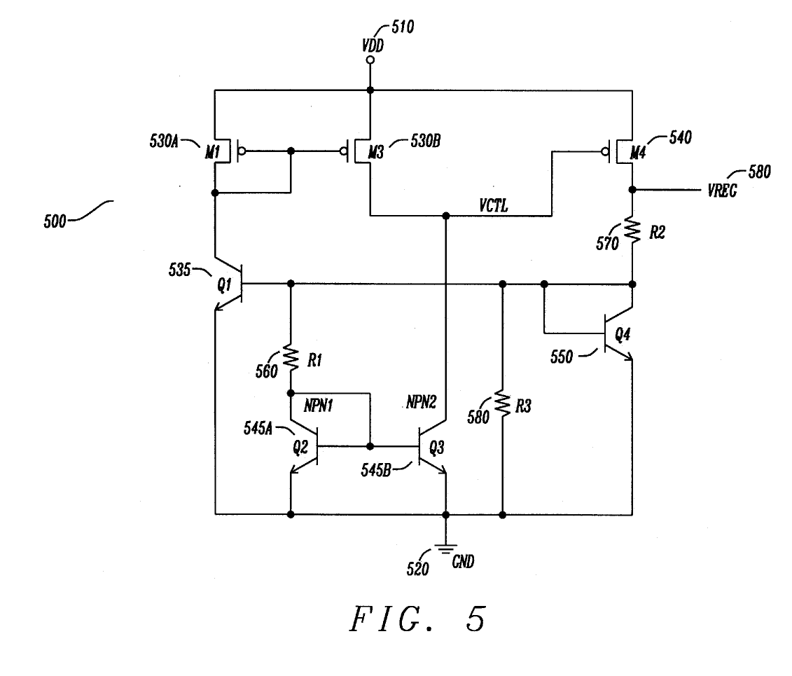

FIG. 6 is a circuit schematic in accordance with the first embodiment of the disclosure;

FIG. 7 is a circuit schematic in accordance with the second embodiment of the disclosure; and,

FIG. 8 is a method in accordance with the embodiment of the disclosure.

### DETAILED DESCRIPTION

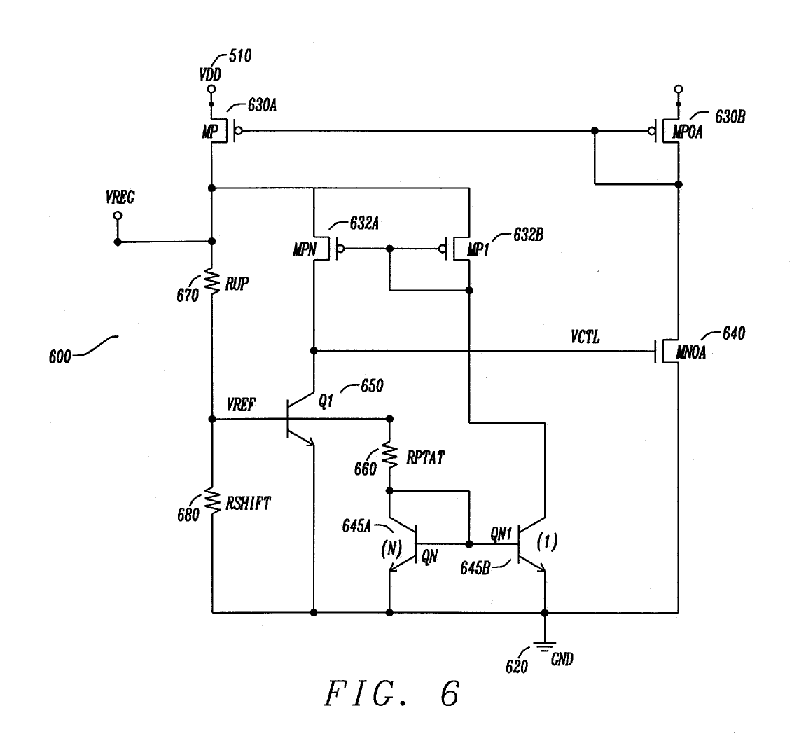

FIG. 6 is a circuit schematic in accordance with the first embodiment of the disclosure. The circuit 600 comprises a power supply 610 and a ground VSS 620. A first p-channel MOSFET current mirror MP 630A and MP 630B sources the circuit 600. A second p-channel MOSFET current mirror MPN 632A and MP1 632B, electrically coupled to p-channel MOSFET MP 630A. The second p-channel MOSFET current mirror provides a 1:N MOSFET width ratio, where transistor MPN 632A has a MOSFET width which is N times wider than transistor MP1 632B. The second p-channel MOSFET current mirror transistor MP1 632B is driven by the current flowing through the collector of the bipolar transistor QN1 645B. The bipolar transistor QN1 645B forms an n-type bipolar current mirror with a second bipolar transistor QN 645A. The second p-channel MOSFET current mirror MPN 632A sources the collector of the bipolar transistor Q1 650 The emitter of the bipolar transistor Q1 650 is electrically connected to the ground VSS 620. The base of the bipolar transistor Q1 650 is electrically coupled to the resistor RPTAT 660, and the resistor network RUP 670 and RSHIFT 680. The p-channel MOSFET MPOA 630B is driven by the current flowing through the n-channel MOSFET MNOA 640A. The gate of the n-channel MOSFET MNOA 640 is the control voltage VCTL. In the circuit 600, the collector-to-emitter current in bipolar transistor QN 645A is mirrored onto bipolar transistor QN1 645B with the ratio N:1. Using a current mirror {QN 645A, QN 645B} limits the current consumption. The current is then copied back to the p-channel current mirror MP1 632B and MPN 632A where the 1:N ratio restores the previous N:1 scaling. Thus, the current in bipolar transistor Q1 650 is compared to the current to QN 645 and the result pushes or pulls the signal line voltage VCTL. This establishes a drive current which establishes the current-mode operational amplifier formed from n-channel MOSFET MNOA 640, and current mirror p-channel MOSFET MPOA 630B and p-channel MOSFET MP 630A, where the ratio MPOA:MP can be very large to be able to inject more current to the output.

The regulator voltage, VREG, is adjusted such that the signal voltage VCTL drives a given current through n-channel transistor MNOA 640; this allows prevention of signal clipping of the signal VCTL. (e.g. VCTL is not clipping up nor down). The regulator voltage VREG is adjusted to match the currents in bipolar transistor Q1 650 and bipolar transistor QN 645A. This method emulates a PTAT, with the advantage that the regulation voltage itself is referenced to the ground VSS 620.

The derivation of the regulation voltage VREG is illustrated in the following equations. First, equating the currents of transistor QN 645A, and transistor Q1 650 where IQN=IQ1. This can be expressed as

$$I ( RPTAT ) = \frac{VBE 1 - VBEN}{RPTAT} = \frac{Δ VBE}{RPTAT}$$

The regulation voltage, VREG and can expressed as

$$VREG = VBE 1 + RUP \cdot I ( RUP ) = VBE 1 + RUP \cdot ( I ( RSHIFT ) + I ( RPTAT ) )$$

$$VREG = VBE 1 + RUP \cdot ( \frac{VBE 1}{RSHIFT} + \frac{Δ VBE}{RPTAT} )$$

The regulation voltage can be expressed as a ratios of the resistors RPTAT 660, resistor RUP 670, and RSHIFT 680

$$VREG = VBE 1 \cdot ( 1 + \frac{RUP}{RSHIFT} ) + Δ VBE \cdot ( \frac{RUP}{RPTAT} )$$

This equation is made of a base-emitter voltage, VBE1 term that decreases with temperature, and a ΔVBE term that increases with temperature. By calculating properly RUP, RPTAT, RSHIFT and N (that is embedded in ΔVBE), the value of VREG can be chosen and also compensate it in temperature.

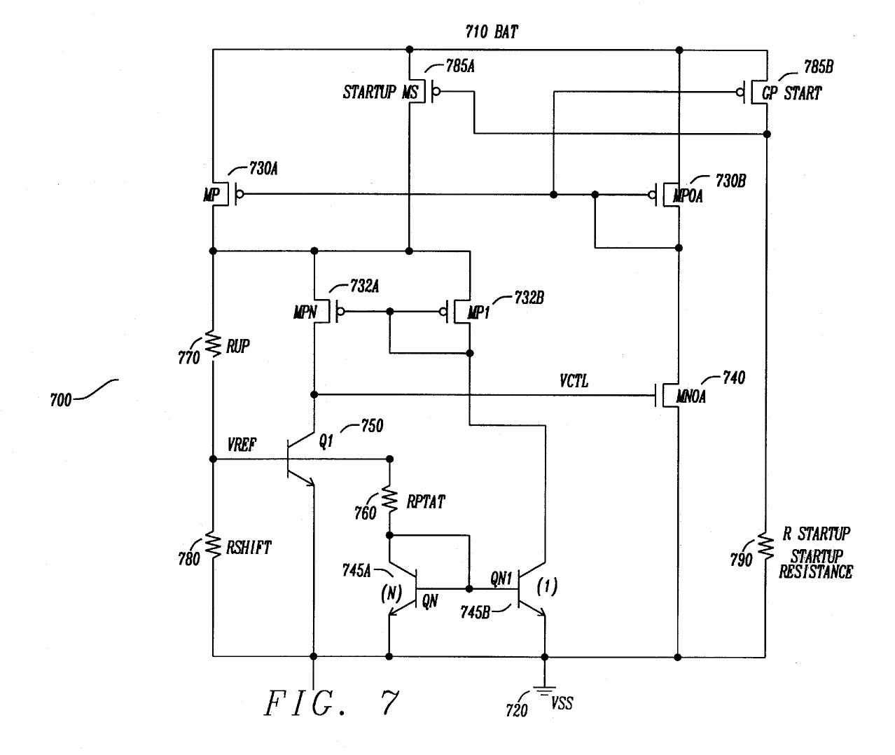

FIG. 7 is a circuit schematic in accordance with the second embodiment of the disclosure. The circuit 700 comprises a power supply VDD 710 and a ground VSS 720. The circuit 700 power supply can be a battery power source (e.g. VDD=VBAT). A p-channel MOSFET current mirror MP 730A and MP 730B sources the circuit 700. A second p-channel MOSFET current mirror MPN 732A and MP1 732B is electrically coupled to p-channel MOSFET MP 730A. The second p-channel MOSFET current mirror provides a 1:N MOSFET width ratio, where transistor MPN 732A has a MOSFET width which is N times wider than transistor MP1 732B. The second p-channel MOSFET current mirror transistor MP1 732B is driven by the current flowing through the collector of the bipolar transistor QN1 745B. The bipolar transistor QN1 745B forms an n-type bipolar current mirror with a second bipolar transistor QN 745A. The second p-channel MOSFET current mirror MPN 732A sources the collector of the bipolar transistor Q1 750. The emitter of the bipolar transistor Q1 750 is electrically connected to the ground VSS 720. The base of the bipolar transistor Q1 750 is electrically coupled to the resistor RPTAT 760, and the resistor network RUP 770 and RSHIFT 780. The p-channel MOSFET MPOA 730B is driven by the current flowing through the n-channel MOSFET MNOA 740A. The gate of the n-channel MOSFET MNOA 740 is the control voltage VCTL.

In the circuit 700, the collector-to-emitter current in bipolar transistor QN 745A is mirrored onto bipolar transistor QN1 745B with the ratio N:1. Using a current mirror {QN 745A, QN 745B} limits the current consumption. The current is then copied back to the p-channel current mirror MPN 732A and MP 1 732B where the 1:N ratio restores the previous N:1 scaling. Thus, the current in bipolar transistor Q1 750 is compared to the current to QN 745 and the result pushes or pulls the signal line voltage VCTL. This establishes a drive current which establishes the current-mode operational amplifier formed from n-channel MOSFET MNOA 740, and current mirror p-channel MOSFET MPOA 730B and p-channel MOSFET MP 730A, where the ratio MPOA:MP can be very large to be able to inject more current to the output. Additionally, the implementation in general does not have to restore exactly the ratio N:1 to 1:N. An implementation when the ratio is not restored to 1:1, but to 1:M or M:1, where M is. As long as this ratio remains constant (using mirror ratios), a PTAT behaviour can also be implemented. For example, this can lead to current IQ1 different from current IQN, but ratio well controlled between both.

The regulator voltage, VREG, is adjusted such that the signal voltage VCTL drives a given current through n-channel transistor MNOA 740; this allows prevention of signal clipping of the signal VCTL. (e.g. VCTL is not clipping up nor down). The regulator voltage VREG is adjusted to match the currents in bipolar transistor Q1 750 and bipolar transistor QN 745A. This method emulates a PTAT, with the advantage that the regulation voltage itself is referenced to the ground VSS 720.

A startup function system includes a p-channel MOSFET 785A, a p-channel MOSFET 785B, and startup resistance 790. The gate of p-channel MOSFET 785 is electrically connected to the drain of p-channel MOSFET 785B, providing a startup signal GPSTART. The gate of p-channel MOSFET 785B is connected to the p-channel current mirror {MP 730A, and MPOA 730B}. The p-channel MOSFET 785B drain is electrically connected to the resistance RSTARTUP 790.

In this embodiment, the PTAT requires a p-channel MOSFET current mirror referenced to the supply from the current mirror MPN 732A and MP1 732B; this can use the rail OUT=VREG. For example, the sources of the p-channel MOSFET current mirror are connected to the battery BAT instead of VREG.

The start-up system components, GPSTART is initially discharged as long as no current flows through the amplifier. This allows the supply to connect to OUT using the “Startup MS” PMOS 785A. Once current starts flowing, GPSTART goes up to the supply and deactivates MS.

The resistance RSTARTUP 790 can be a passive or active element. For example, the resistance RSTARTUP 790 can be a source-drain resistance of a MOSFET or plurality of MOSFETs. In this embodiment, a very large startup resistance RSTARTUP 790 is desired to activate the regulator.

Other equivalent circuit embodiments can be utilized. High-voltage transistors can replace the low-voltage transistor components within the circuit embodiment. For example, the transistor MNOA 740 can be a high-voltage transistor to drive the transistors MPOA 730B, and transistor MP 730A in a high voltage domain. Additionally, other equivalent circuit embodiments also can be utilized. It is worth noting that all the bipolar NPN transistors may be replaced by NMOS in weak inversion, to eliminate the base-current errors and to reduce the total size.

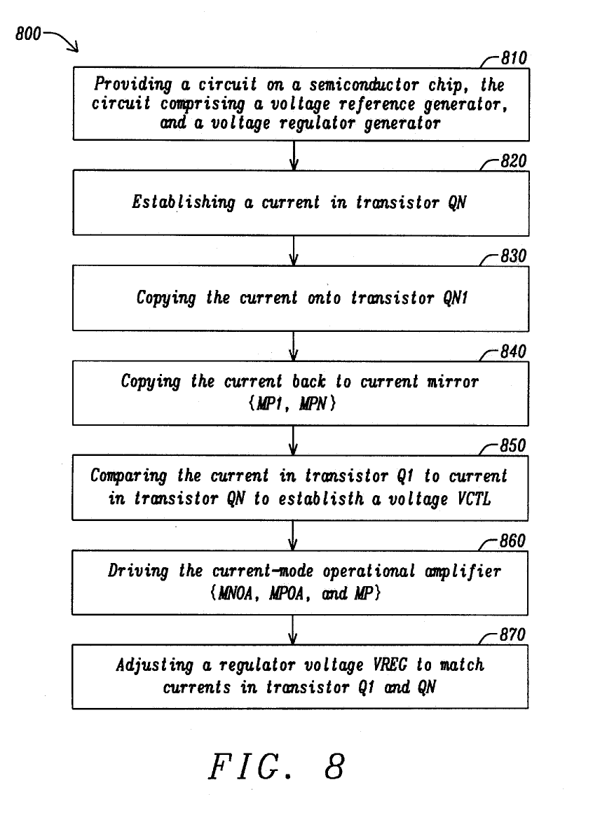

FIG. 8 is a method in accordance with the embodiment of the disclosure. A method is disclosed in accordance with the embodiment of the disclosure. A method for providing a temperature compensated high voltage 800, comprising the steps of a first step 810 providing a circuit on a semiconductor chip, the circuit comprising a voltage reference generator, and a voltage regulator generator, a second step 820 establishing a current in transistor QN, a third step 830 copying the current onto transistor QN1, a fourth step 840 copying the current back to current mirror {MP1, MPN}, a fifth step 850 comparing the current in transistor Q1 to current in transistor QN to establish a voltage VCTL, a sixth step 860 driving the current-mode operational amplifier {MNOA, MPOA, and MP}, a seventh step 870 adjusting a regulator voltage VREG to match currents in transistor Q1 and QN.

In the method in accordance with the embodiment, the third step 830, the current in QN is copied onto QN1 with the ratio N:1 (to limit the consumption).

In the method in accordance with the embodiment, the fourth step 840 the current is copied back to {MP1, MPN} where the 1:N ratio restores the previous N:1 scaling.

In the method in accordance with the embodiment, the fifth step 850 the current in Q1 is compared to the current to QN and the result pushes or pulls the line VCTL.

In the sixth step 860, this drives the current mode operational amplifier {MNOA, MPOA and MP} where the ratio MPOA:MP can be very large to be able to inject more current to the output.

In the seventh step 870, VREG is adjusted such that VCTL drives a given current through MNOA, and this means VCTL is not clipping up nor down: in other words VREG is adjusted to match the currents in Q1 and QN. We have thus emulated a PTAT, with the advantage compared to prior art that the regulation itself is referenced to the ground.

In the method in accordance with the embodiment, this can be further described from the equation from the equating of the current through transistor QN and the transistor Q1, starting with IQN=IQ1. This means:

$$I ( RPTAT ) = \frac{VBE 1 - VBEN}{RPTAT} = \frac{Δ VBE}{RPTAT}$$

In the method in accordance with the embodiment, the derivation of the regulated voltage VREG can be derived according to VREG:

$$VREG = VBE 1 + RUP . I ( RUP ) = VBE 1 + RUP \cdot ( I ( RSHIFT ) + I ( RPTAT ) )$$

$$VREG = VBE 1 + RUP \cdot ( \frac{VBE 1}{RSHIFT} + \frac{Δ VBE}{RPTAT} )$$

### Finally:

$$VREG = VBE 1 \cdot ( 1 + \frac{RUP}{RSHIFT} ) + Δ VBE \cdot ( \frac{RUP}{RPTAT} )$$

This equation is made of a VBE1 term that decreases with temperature, and a ΔVBE term that increases with temperature. By calculating properly RUP, RPTAT, RSHIFT and N (that is embedded in ΔVBE), we can choose both the value of VREG and also compensate it in temperature.

Other equivalent circuit embodiments are also can be utilized. Equivalent reference voltage and voltage regulator generators can be merged to provide temperature compensation at voltages above 1.2 V.

It should be noted that the description and drawings merely illustrate the principles of the proposed methods and systems. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the proposed methods and systems and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Other advantages will be recognized by those of ordinary skill in the art. The above detailed description of the disclosure, and the examples described therein, has been presented for the purposes of illustration and description. While the principles of the disclosure have been described above in connection with a specific device, it is to be clearly understood that this description is made only by way of example and not as a limitation on the scope of the disclosure.

What is claimed is:

1. A circuit providing a temperature compensated voltage comprising a a voltage regulator circuit configured to provide a regulator voltage;
a voltage reference circuit configured to provide a reference voltage;
a comparison (Note: this is not related to any startup function; only FIG. 7) shows the startup add-on) circuit configured to provide a control voltage VCTL; and
an operational amplifier configured to provide amplification and coupling to said startup circuit.

2. The circuit, as recited in claim 1, wherein said voltage reference circuit comprises of a current mirror with a bipolar junction transistor QN and a bipolar junction transistor QN1 configured to provide a collector-to-emitter current in bipolar transistor QN mirrored onto bipolar transistor QN 1 with the ratio N:1.

3. The circuit, as recited in claim 2, wherein said operational amplifier comprises of a p-channel MOSFET current mirror MP and MPOA configured to provide a source current for said circuit coupled to a second p-channel current mirror of transistor MPN and MP1 wherein transistor has a MOSFET width which is N times wider than transistor MP1.

4. The circuit, as recited in claim 3, wherein said second p-channel MOSFET current mirror is configured to provide a source current for said current mirror to the collector of bipolar junction transistor npn QN1 and the collector of bipolar junction npn transistor Q1.

5. The circuit, as recited in claim 4, wherein said second p-channel MOSFET current mirror transistor MPN is configured to provide a control signal VCTL for said operational amplifier n-channel MOSFET MNOA.

6. The circuit, as recited in claim 5, where said operational amplifier is configured to provide a startup current IRUP.

7. The circuit, as recited in claim 6, wherein said voltage reference circuit is configured to provide a reference voltage VREF with a resistor divider network formed from the startup resistor RUP, and shift resistor RSHIFT.

8. The circuit, as recited in claim 6, is configured to provide the emitter of the bipolar transistor Q1 to be electrically connected to the ground VSS, and configured to provide the base of the bipolar transistor Q1 to be electrically coupled to the resistor RPTAT, and the resistor network startup resistor RUP, and shift resistor RSHIFT.

9. The circuit, as recited in claim 8, wherein said npn bipolar junction current mirror QN, and QN1, is configured to limit the current consumption.

10. The circuit, as recited in claim 9, wherein the circuit is configured to provide a copy to said second current mirror where the 1:N ratio restores the previous N:1 scaling.

11. The circuit, as recited in claim 9, wherein the circuit is configured to provide a copy to said second current mirror where the current mirror ratio is 1:M or M:1 wherein M is an integer.

12. The circuit, as recited in claim 11, wherein the current mirror ratios remains a constant.

13. The circuit, as recited in claim 12, wherein the current IQ1 is different from current IQN and the mirror ratio is well controlled in said first and second current mirrors.

14. The circuit, as recited in claim 10, wherein said voltage regulator is configured to provide a regulator voltage, VREG, adjusted such that the said control voltage VCTL drives a given current through n-channel transistor MNOA, avoiding signal clipping of the said control signal voltage VCTL.

15. The circuit, as recited in claim 14, wherein said voltage regulator is configured to provide an adjustment of regulator voltage VREG to match the currents in said bipolar transistor Q1 and said bipolar transistor QN, emulating a PTAT, wherein said regulation voltage VREG is referenced to the ground VSS.

16. The circuit, as recited in claim 14, wherein said voltage regulator is configured to provide an adjustment of regulator voltage VREG ratio with a fixed value M wherein the currents in said bipolar transistor Q1 and said bipolar transistor QN, emulating a PTAT, wherein said regulation voltage VREG is referenced to the ground VSS.

17. The circuit, as recited in claim 15, further comprising of
a startup resistor RSTARTUP;
a first startup p-channel MOSFET configured to provide a current for said second p-channel MOSFET current mirror MPN and MP1; and
a second startup p-channel MOSFET is configured to provide current to said startup resistor RSTARTUP.

18. The circuit, as recited in claim 17, wherein said first startup p-channel MOSFET is configured to provide a signal GPSTART on its gate electrode.

19. The circuit, as recited in claim 17, wherein said second startup p-channel MOSFET whose gate is configured to said operational amplifier first p-channel MOSFET current mirror gate electrode of transistor MP and MPOA.

20. A method of providing a temperature compensated high voltage comprising the steps of:
(a) providing a circuit on a semiconductor chip, the circuit comprising a voltage reference generator, and a voltage regulator generator,
(b) establishing a current in transistor QN,
(c) copying the current onto transistor QN1,
(d) copying the current back to current mirror {MP1, MPN},
(e) comparing the current in transistor Q1 to current in transistor QN to establish a voltage VCTL,
(f) driving the current-mode operational amplifier {MNOA, MPOA, and MP}, and,
(g) adjusting a regulator voltage VREG to match currents in transistor Q1 and QN.

21. The method of claim 20, wherein said current in transistor QN is copied onto transistor QN1 with the ratio N:1 to limit the consumption.

22. The method of claim 20, wherein the current is copied back to {MP1, MPN} where the 1:N ratio restores the previous N:1 scaling.

23. The method of claim 20, wherein the current in Q1 is compared to the current to QN and the result pushes or pulls the line VCTL.

24. The method of claim 20, wherein said signal VCTL drives the current mode operational amplifier {MNOA, MPOA and MP} where the ratio MPOA:MP can be significantly larger than unity.

25. The method of claim 20, wherein a regulated voltage, VREG, is adjusted such that control voltage VCTL drives a given current through MNOA.

26. The method of claim 20, wherein the regulated voltage, VREG, is adjusted to match the currents in Q1 and QN to emulate a PTAT.

27. The method of claim 20, wherein the current of QN and Q1 are equated according to
$$I ( RPTAT ) = \frac{VBE 1 - VBEN}{RPTAT} = \frac{Δ VBE}{RPTAT}$$

28. The method of claim 27, wherein the derivation of the regulated voltage VREG can be derived according to VREG:
$$VREG = VBE 1 + RUP \cdot I ( RUP ) = VBE 1 + RUP \cdot ( I ( RSHIFT ) + I ( RPTAT ) )$$
$$VREG = VBE 1 + RUP \cdot ( \frac{VBE 1}{RSHIFT} + \frac{Δ VBE}{RPTAT} )$$
$$or$$
$$VREG = VBE 1 \cdot ( 1 + \frac{RUP}{RSHIFT} ) + Δ VBE \cdot ( \frac{RUP}{RPTAT} )$$

29. The method of claim 28, wherein said base-emitter voltage, VBE1 term decreases with temperature, and a ΔVBE term increases with temperature.

30. The method of claim 29, wherein calculating start up resistor RUP, RPTAT, shift resistor RSHIFT and N (that is embedded in ΔVBE), a value of VREG and temperature compensation can be evaluated.

31. A method of providing a temperature compensated high voltage comprising the steps of:
(a) providing a circuit on a semiconductor chip, the circuit comprising a voltage reference generator, and a voltage regulator generator,
(b) establishing a current in transistor QN,
(c) copying a non-identical current onto transistor QN1,
(d) copying a non-identical current back to current mirror {MP1, MPN},
(e) comparing the current in transistor Q1 to current in transistor QN to establish a voltage VCTL,
(f) driving the current-mode operational amplifier {MNOA, MPOA, and MP}, and,
(g) adjusting a regulator voltage VREG without matching currents in transistor Q1 and QN.

32. The method of claim 31, wherein said current in transistor QN is a non-identical current onto transistor QN1 to limit the consumption.

33. The method of claim 31, wherein a non-identical current is copied back to {MP1, MPN} where the 1:N ratio does not restore the previous N:1 scaling.

34. The method of claim 31, wherein the current in Q1 is compared to the current to QN and the result pushes or pulls the line VCTL wherein said current mirror ratio is non-identical and well controlled.

35. The method of claim 31, wherein said signal VCTL drives the current mode operational amplifier {MNOA, MPOA and MP} where the ratio MPOA:MP can be unity or significantly larger than unity.

36. The method of claim 31, wherein a regulated voltage, VREG, is adjusted such that control voltage VCTL drives a given current through MNOA.

37. The method of claim 31, wherein the regulated voltage, VREG, is not adjusted to match the currents in Q1 and QN to emulate a PTAT.

38. The method of claim 31, wherein the current of QN and Q1 are not equated

39. The method of claim 38, wherein said base-emitter voltage, VBE1 term decreases with temperature, and a ΔVBE term increases with temperature.

40. The method of claim 39, wherein calculating start up resistor RUP, RPTAT, shift resistor RSHIFT and N (that is embedded in ΔVBE), a value of VREG and temperature compensation can be evaluated.
